(19) United States
(12) Patent Application Publication
(10) Pub. No.: US 2018/0292684 A1
(43) Pub. Date: Oct. 11, 2018

(54) LASER OSCILLATION DEVICE

(71) Applicant: INDUCTRY-ACADEMIC COOPERATION FOUNDATION GYEONGSANG NATIONAL UNIVERSITY, Gyeongsangnam-do (KR)

(72) Inventor: Mi-yun JEONG, Seoul (KR)

(21) Appl. No.: 15/578,023

(22) PCT Filed: Jan. 27, 2016
(86) PCT No.: PCT/KR2016/000836

§ 371 Date: Nov. 29, 2017

(30) Foreign Application Priority Data
May 29, 2015 (KR) 10-2015-0075881

(51) Int. Cl. G02F 1/13; G02F 1/1341; G02F 1/1339; G02F 1/1337; H01S 3/00

(52) U.S. Cl. CPC G02F 1/132; G02F 1/1341; G02F 1/13394; G02F 1/133784; H01S 3/0085; G02F 2001/13396; G02F 1/133723

(57) ABSTRACT

Disclosed is a laser oscillation device. The laser oscillation device comprises: a first substrate; a second substrate which is provided above the first substrate and forms a wedge cell between the second substrate and the first substrate; a liquid crystal layer, formed by a liquid crystal having the same pitch, which is injected into the wedge cell; and a temperature controller system which is connected to both sides of the wedge cell and controls the temperatures of both sides of the wedge cell to be different from each other.

### TECHNICAL FIELD

The present invention pertains to a laser oscillation device and, more particularly, to a laser oscillation device which uses a wedge cell capable of continuous wavelength tuning lasing in a predetermined wavelength region.

### BACKGROUND ART

In general, as a laser oscillation device, a cell having a uniform thickness is used. Conventional laser oscillation devices are made by using cholesteric liquid crystals injected into a cell having a uniform thickness in order to realize wavelength tuning and then using pitch or UV tight which varies depending on the temperature of the liquid crystal.

However, the cholesteric liquid crystal structure used in the conventional laser oscillation device functions as a laser resonator, and a cell having a uniform thickness interval corresponds to a Fabry-Perot laser cavity having a fixed length of the laser resonator. Thus, in the case of rasing using a conventional laser oscillation device, the laser shows oscillation of the laser line in a wide wavelength range, but confronts the result of discontinuous laser wavelength variation, that is, discontinuous laser wavelength oscillation.

In order to solve such a problem, in case of the conventional art, a cholesteric liquid crystal having two different pitches in a wedge-shaped cell is injected from both sides of the cell and then a continuous pitch gradient is formed by using diffusion and laser wavelength can be generated.

However, in the case of a general liquid crystal, after a few months, the gradient due to the density of molecules formed disappears due to molecular diffusion, and the change of the laser wavelength is disappeared. Further, in the case of the polymerized liquid crystal, there is a problem that it is difficult to make a process of continuously changing the concentration of the molecules and a long production time is required.

### DETAILED DESCRIPTION OF INVENTION

### Technical Tasks

The present disclosure is purposed to provide a laser oscillation device which generates a continuous laser wavelength by forming pitch gradient by a temperature difference in a wedge cell.

### Means for Solving Tasks

The laser oscillation device according to an exemplary embodiment includes a first substrate; a second substrate which is provided above the first substrate and forms a wedge cell between the second substrate and the first substrate; a liquid crystal layer, formed by a liquid crystal having the same pitch, which is injected into the wedge cell; and a temperature controller which is connected to both sides of the wedge cell and controls the temperatures of both sides of the wedge cell to be different from each other.

The injected liquid crystal may form a continuous pitch gradient by a difference of temperature of the wedge cell.

The liquid crystal could be polymerized by radiating UV or applying heat after the pitch gradient may be formed.

The laser oscillation device may further include at least two spacers provided on both sides of the first substrate and the second substrate to form the wedge cell.

The height of the at least two spacers which correspond to a distance between the first substrate and the second substrate may be different from each other.

The liquid crystal may be cholesteric liquid crystal composed of nematic liquid crystal and chiral dopant, and wherein the pitch may be determined based on relative concentration ratio of the nematic liquid crystal and the chiral dopant.

### Effect of Invention

As described above, according to various embodiments of the present invention, it is possible to provide a laser oscillation device that generates a continuous laser wavelength which can be semi-permanently used, and can reduce the manufacturing time of the laser oscillation device.

### BRIEF DESCRIPTION OF DRAWINGS

FIG. 1 is a sectional view of a laser oscillation device before cholesteric liquid crystal is injected according to an exemplary embodiment.

FIG. 2 is a sectional view describing a pitch change of liquid crystal when liquid crystal is injected into the wedge-shaped cell of FIG. 1, but temperature controller attached to both sides is at room temperature.

FIGS. 3 and 4 illustrate a pitch gradient of a liquid crystal in a wide region by forming a temperature gradient of a cell by changing the temperature of a temperature controller attached to both ends of a wedge-shaped cell injected with liquid crystal according to an embodiment of the present invention.

FIG. 5 is a view illustrating laser wavelength which is generated according to a change in x-position of pump laser beam of a wedge-shaped cell at room temperature of FIG. 2 according to an exemplary embodiment.

FIG. 6 is a view illustrating a laser wavelength generated according to an x-position change of a pump laser beam of a wedge-shaped cell when the temperature gradient in FIGS. 3 and 4 is formed according to an embodiment of the present invention.

FIG. 7 is a view illustrating strength of laser according to laser wavelength according to an exemplary embodiment.

### BEST MODE FOR CARRYING OUT THE INVENTION

The present embodiment will be further described with reference to the enclosed drawings.

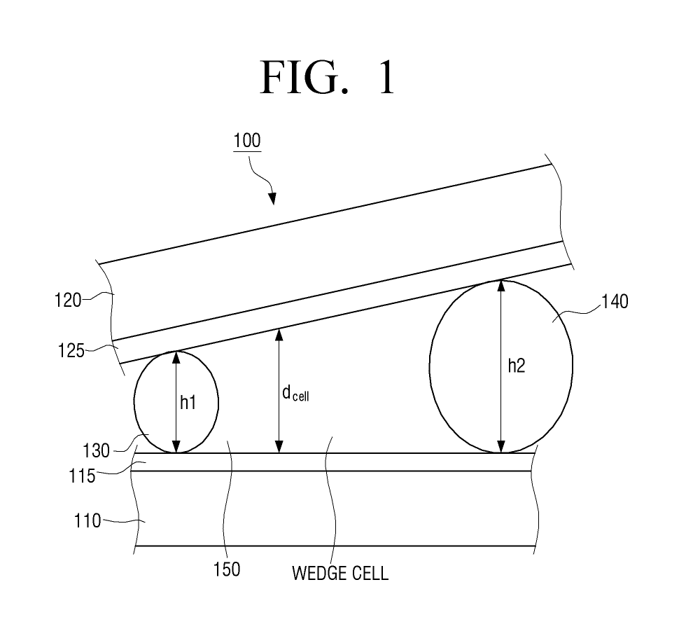

FIG. 1 is a sectional view of a laser oscillation device before cholesteric liquid crystal is injected according to an exemplary embodiment.

Referring to FIG. 1, the laser oscillation device 100 includes a first substrate 110, a second substrate 120, a first spacer 130, a second spacer 140, and a liquid crystal layer 150. As the first substrate 110 and the second substrate 120, a glass substrate such as a slide glass or an Indium Tin Oxide (ITO) transparent electrode may be used. When the first substrate 110 is a lower substrate, the second substrate 120 may be inclined by a predetermined angle with respect to the first substrate 110. The inclination of the second substrate 120 may be determined by the first spacer 130 and the second spacer 140.

In order to fabricate the laser oscillation device 100, a cell must be made first. To do this, a polyimide is coated on the upper surface of the first substrate 110 and the lower surface of the second substrate 120 and the coated polyimide film is rubbed-polyimide to form liquid crystal alignment layers 115 and 125. The liquid crystal alignment layers 115 and 125 may be formed of various materials such as polyamide, polyamide-imide and polyphenylene oxide as well as polyimide.

After the rubbing process, a first spacer 130 and a second spacer 140 having different sizes (for example, different in height (h1, h2)) are provided between the first substrate 110 and the second substrate 120 to form a wedge cell in a hollow stale between the first substrate 110 and the second substrate 120. That is, in order to form a wedge-shaped cell between the first substrate 110 and the second substrate 120, the first spacer 110 and the second spacer 120 are provided on both sides between the first substrate 110 and the second substrate 120.

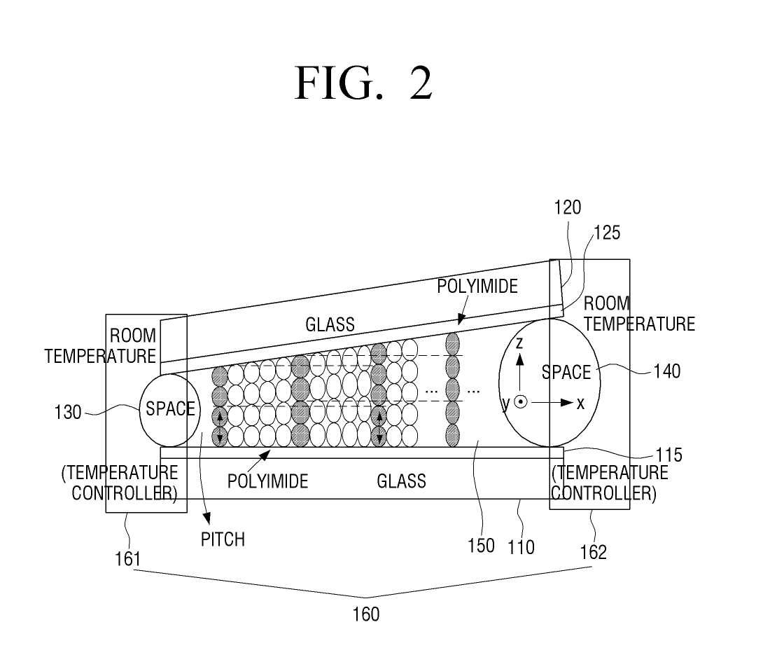

FIG. 2 is a sectional view describing a pitch change of liquid crystal when liquid crystal is injected into the wedge-shaped cell of FIG. 1, but temperature controller attached to both sides is at room temperature.

When the wedge-shaped cells are formed as shown in FIG. 2, the liquid crystal layer 150 can be formed by injecting the liquid crystal having the same pitch into the wedge-shaped cells. In this case, the liquid crystal may be not only a cholesteric liquid crystal but also another liquid crystal which can be changed into polymer cholesteric by UV or heat.

The cholesteric liquid crystal is produced by mixing a nematic liquid crystal with a chiral dopant. The pitch of the liquid crystal can be determined according to the ratio of the nematic liquid crystal mixed with the cholesteric liquid crystal to the chiral dopant. At this time, various laser dyes can be added to the cholesteric liquid crystal as necessary to broaden or narrow the laser wavelength band.

The laser dye can use a dye having a fluorescence spectral range in a region where laser oscillation is to be continuously performed. That is, laser dyes having a fluorescence spectral range can be added to each cholesteric liquid crystal in a region where laser tuning is to be performed.

The cholesteric liquid crystal having the same pitch is injected into the wedge-shaped cells between the first substrate 110 and the second substrate 120. After a predetermined period of time, a laser resonator may be formed. Specifically, a laser resonator array in which the length of the pitch continuously increases and decreases in the X-axis direction after a certain period of time is passed from injecting the cholesteric liquid crystal at room temperature may be formed. In this case, one or more pigments may be added to the cholesteric liquid crystal. Also, the pitch can be proportional to the thickness (d) of the wedge-shaped cell. That is, as the thickness (d) of the wedge-shaped cell increases, the length of one pitch may increase.

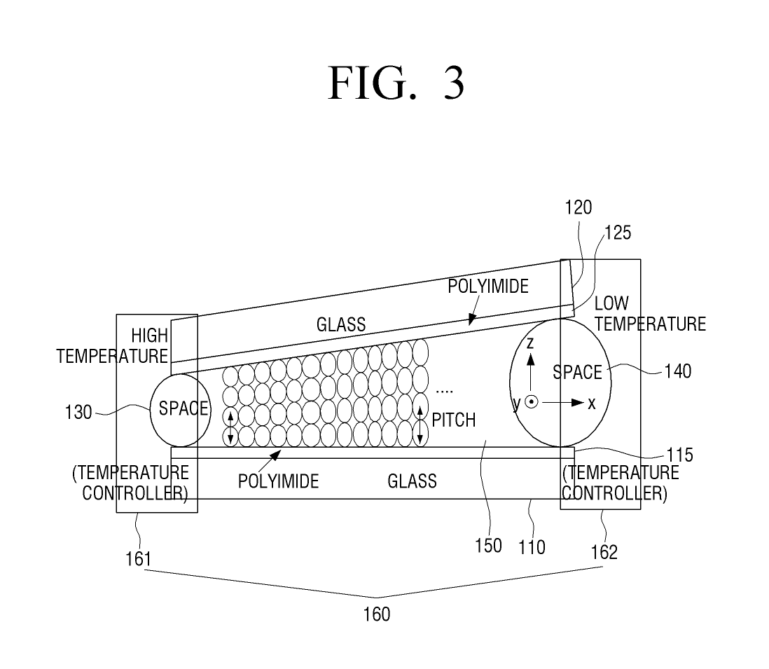

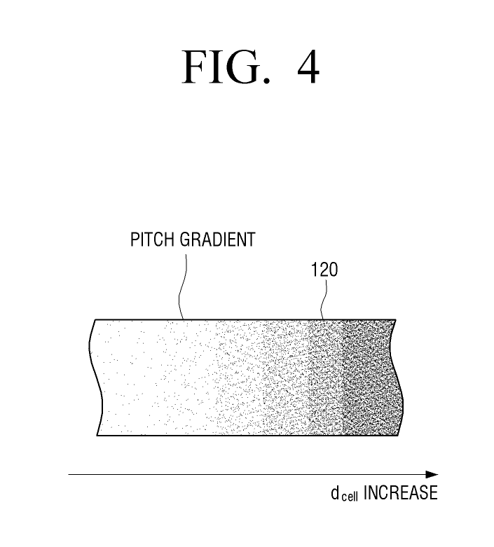

FIGS. 3 and 4 illustrate a pitch gradient of a liquid crystal in a wide region by forming a temperature gradient of a cell by changing the temperature of a temperature controller attached to both ends of a wedge-shaped cell injected with liquid crystal according to an embodiment of the present invention.

Referring to FIG. 3, a temperature controller system 160 capable of controlling the temperature of the cell may be connected to both sides of the wedge-shaped cell, so that temperatures of both sides of the wedge-shaped cell can be made different. For example, the temperature of the wedge-shaped cell whose thickness (d) is thicker can be made lower than the temperature of the temperature controller 162 whose thickness (d) is thinner. That is, the temperature of the thicker temperature controller 161 can be set to a low temperature, and the temperature of the thinner temperature controller 162 can be set to a high temperature. Alternatively, depending on the temperature characteristics of the liquid crystal, the temperature of the temperature controller 161 whose thickness (d) is wider is higher than the temperature of the temperature controller 162 whose thickness (d) is smaller. In this case, a continuous temperature gradient is formed in the x-axis direction of the wedge-shaped cell to form a continuous laser resonator array, and the laser wavelength can be continuously generated in a wide wavelength region. In this case, by controlling the temperature of the temperature controller system 160 to adjust the temperature gradient, the wavelength variable region can be actively adjusted.

Further, the position of the band gap can be determined by adjusting the relative concentration ratio of the nematic liquid crystal and the chiral dopant in the case of the cholesteric liquid crystal. In the case of using a pump beam as the laser, the laser whose tuning wavelength is continuously tuned can be oscillated by moving the position of the pump beam from the side where the thickness (d) of the wedge-shaped cell from a larger thickness to a smaller thickness.

In addition, this laser oscillation device can actively change the laser wavelength generated by using a cholesteric liquid crystal wedge type cell to which a dye is added. Specifically, by making one cholesteric liquid crystal wedge-shaped cell have a high temperature at one end and a low temperature at the other end, a temperature gradient is formed in the cell to form a pitch gradient of the liquid crystal by temperature It is possible to generate a continuous laser wavelength.

According to an embodiment of the present invention, after the cholesteric liquid crystal is injected into the wedge-shaped cell, the temperature of both sides of the wedge-shaped cell is controlled differently, and the continuous wavelength variable Polymer Cholesteric Liquid Crystal (PCLC) can be fabricated by irradiating UV light or applying heat at the time when the resonator is formed. The time at which the continuous wave-length variable resonator is formed, that is, the time at which UV light or heat is applied, can be determined by a choice of a person designing the invention, and the person designing the invention can select a different viewpoint for each desired wavelength variable region.

FIG. 4 is a view illustrating a pitch gradient in a case where temperatures of both sides of a wedge-shaped cell are different from each other according to an embodiment of the present invention. As shown in FIG. 4, when the cholesteric liquid crystal having the same pitch is injected into the wedge-shaped cells, the temperature gradient at both sides of the wedge-shaped cells is changed, and a continuous pitch gradient may be generated.

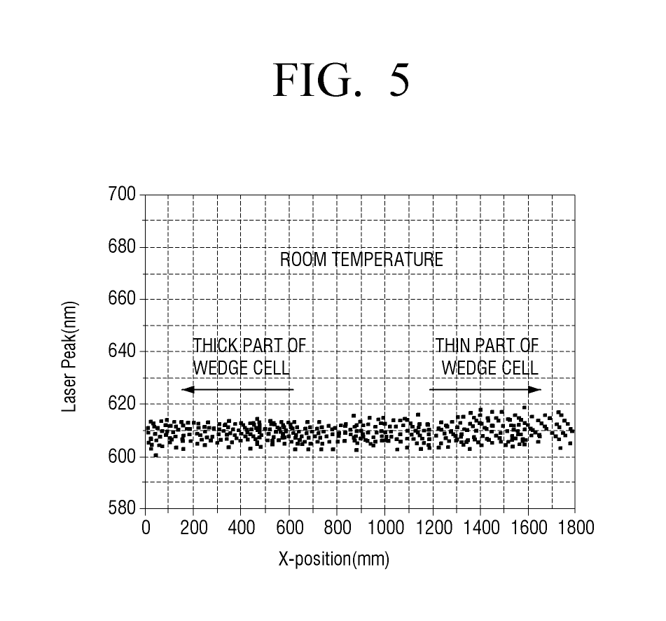

FIG. 5 is a view illustrating laser wavelength which is generated according to a change in x-position of pump laser beam of a wedge-shaped cell at room temperature of FIG. 2 according to an exemplary embodiment.

Referring to FIG. 5, at a room temperature, according to a position of a wedge-shaped cell to which cholesteric liquid crystal is injected, it can be confirmed that the laser line is tuned in a range of 5 nm to 7 nm.

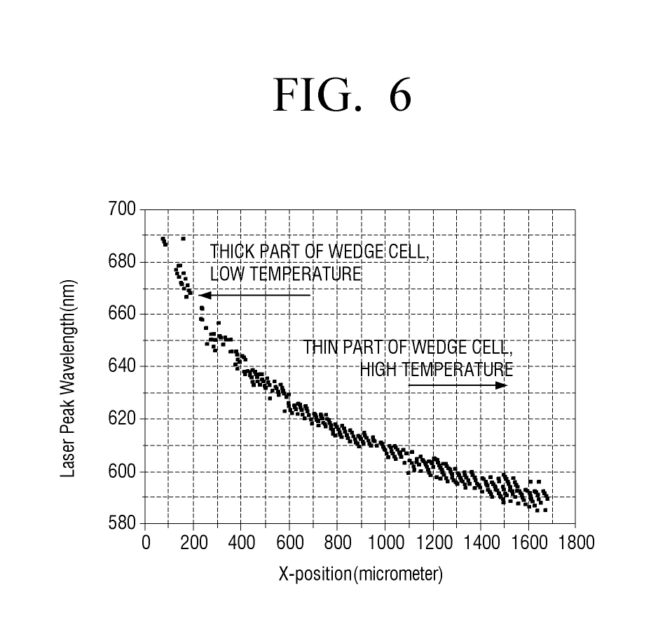

FIG. 6 is a view illustrating a laser wavelength generated according to an x-position change of a pump laser beam of a wedge-shaped cell when the temperature gradient in FIGS. 3 and 4 is formed according to an embodiment of the present invention.

Referring to FIG. 6, a thermostat is connected to both sides of the wedge-shaped cell into which the cholesteric liquid crystal is injected, so that the thickness of the wedge-shaped cell can be adjusted to a low temperature and the thinner the wedge-shaped cell can be controlled to a high temperature. In this case, as the wedge-shaped cell moves from the thicker side (low temperature) to the thinner side (high temperature) in the x-axis direction, the peak wavelength of the laser can be decelerated continuously.

In addition, the cholesteric liquid crystal forms a continuous pitch gradient by the combination of the wedge-shaped cell structure and the temperature gradient, thereby forming a continuous laser resonator array to continuously generate the laser wavelength in a wide wavelength region.

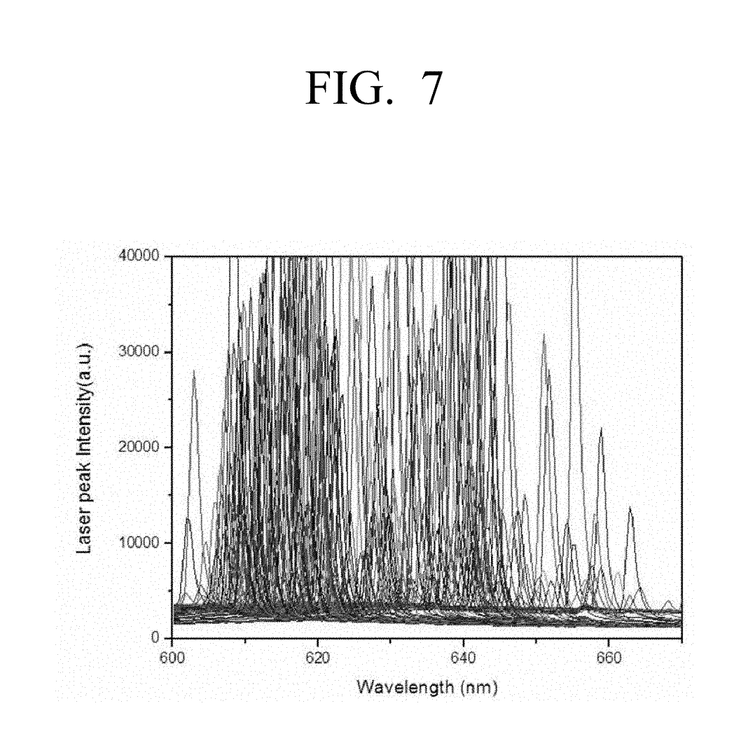

FIG. 7 is a view illustrating strength of laser according to laser wavelength according to an exemplary embodiment.

Referring to FIGS. 5 and 7, when the laser tuning range is 5 nm to 7 nm at room temperature, when the temperature gradients are formed on both sides of the wedge-shaped cell into which the cholesteric liquid crystal is injected, the laser tuning range is extended 10 times or more, and it can be confirmed that the line is continuously tunable in the range of 590 nm to 670 nm.

In addition, when a resonator is fabricated by forming a temperature gradient in the form of a wedge-shaped cell, the length of the resonator can be continuously varied, and a cholesteric liquid crystal having a pitch corresponding to a mode for continuously varying the length of the resonator may form pitch gradient in a resonate and continuously oscillate lasing.

In addition, the continuously tunable lasing interval can be adjusted by changing the relative concentration ratio of the nematic liquid crystal and chiral dopant, or by changing the point at which the solidification is performed by irradiating the UV. Therefore, even when fabricating a laser oscillation device using UV curable PCLC, it is possible to continuously change the wavelength in a section of several hundred nanometers or more, that is, 100 nm or more.

According to the present invention, it is possible to realize a continuous wide-wavelength variable lasing in a visible region (VIS region) by using cholesteric or polymeric cholesteric in a non-polymeric form, and this principle may be applied to both the ultraviolet rays (UV) region, visible rays (VIS) region, or infrared rays (IR) region, and it is possible to realize continuous wavelength modulation in a range of several tens of nanometers or several hundreds of nanometers.

That is, according to the present invention, it is possible to manufacture a laser capable of continuously variable wavelength lasing in a range of several hundreds nm or more in a wedge-shaped optical device fabricated from a cholesteric liquid crystal and a laser dye. In particular, since the present invention can continuously generate a monochromatic laser line in a range of about 100 nm or more without any additional optical element, it is possible to manufacture a tunable laser of an ultrasmall size and high efficiency, and this can be used independently as a laser source.

The present invention is also more efficient than the conventional continuous variable tunable laser system, Optical Parametric Oscillator (OPO), and provides all of the advantages offered by conventional cholesteric liquid crystal lasers. Accordingly, the present invention can be applied not only to lasers but also to optical science, spectroscopic optical devices, and optical industry, and in particular, it can increase the signal transmission efficiency of optical communication when applied to optical communication.

The foregoing exemplary embodiments and advantages are merely exemplary and are not to be construed as limiting the inventive concept. The exemplary embodiments may be readily applied to other types of device or apparatus. Also, the description of the exemplary embodiments is intended to be illustrative, and not to limit the scope of the inventive concept, and many alternatives, modifications, and variations will be apparent to those skilled in the art.

What is claimed is:

1. A laser oscillation device comprising:
a first substrate;
a second substrate which is provided above the first substrate and forms a wedge cell between the second substrate and the first substrate;
a liquid crystal layer, formed by a liquid crystal having the same pitch, which is injected into the wedge cell; and
a temperature controller system which is connected to both sides of the wedge cell and controls the temperatures of both sides of the wedge cell to be different from each other.

2. The laser oscillation device of claim 1, wherein the injected liquid crystal forms a continuous pitch gradient by a difference of temperature of the wedge cell.

3. The laser oscillation device of claim 2, wherein the liquid crystal becomes polymer by radiating UV or applying heat after the pitch gradient is formed.

4. The laser oscillation device of claim 1, further comprising:
at least two spacers provided on both sides of the first substrate and the second substrate to form the wedge cell.

5. The laser oscillation device of claim 4, wherein height of the at least two spacers which correspond to a distance between the first substrate and the second substrate is different from each other.

6. The laser oscillation device of claim 1, wherein the liquid crystal is cholesteric liquid crystal composed of nematic liquid crystal and chiral dopant, and wherein the pitch is determined based on relative concentration ratio of the nematic liquid crystal and the chiral dopant.
